(19) United States
(12) Patent Application Publication
(10) Pub. No.: US 2019/0208751 A1
(43) Pub. Date: Jul. 11, 2019

(54) BRACKET AND ASSEMBLY FOR RECEPTACLES IN AQUEOUS FARMING SYSTEM

(71) Applicant: Local Urban Vegetables, LLLP, Whittier, CA (US)

(72) Inventors: Morris Gasmer, Whittier, CA (US); Hamid Reza Ghalambor, Whittier, CA (US); Kristopher Russell, Whittier, CA (US)

(21) Appl. No.: 16/230,475

(22) Filed: Dec. 21, 2018

Related U.S. Application Data
(60) Provisional application No. 62/608,819, filed on Dec. 21, 2017.

(51) Int. Cl. A01K 63/00; A01K 61/10; A01G 31/06

(52) U.S. Cl. CPC A01K 63/006; A01G 9/024; A01G 31/06; A01K 61/10

(57) ABSTRACT

A bracket for holding a plurality of plant receptacles for use in an automated systems in an aqueous farming system.

### CROSS REFERENCE TO RELATED APPLICATION

This application claims the benefit of the filing date of U.S. Provisional Patent Application No. 62/608,819, filed on Dec. 21, 2017, the disclosure of which is incorporated by reference herein.

### FIELD OF THE INVENTION

The present invention relates generally to aqueous farming systems, and more particularly to a bracket useful in harvesting plants in aqueous farming systems.

### BACKGROUND

In aqueous farming a plant may be placed in an opening of a barrier. A root system of the plant is in an aqueous environment on one side of the barrier, and a canopy including the stem and leaves of the plant is exposed to an atmospheric environment on an opposing side of the barrier. The aqueous environment may be a liquid environment, as is the case for hydroponically grown crops, or a mist environment, as is the case for aeroponically grown crops. The barrier may be a floor or other construct, for example a mesh, or in some cases a wall or wall-like structure.

Removing a plant from the opening in the barrier without damaging fruits, vegetables and/or other portions of the plant canopy may be difficult. This may be especially true if a mechanical device may be used for harvesting operations.

### BRIEF SUMMARY OF THE INVENTION

In accordance with some embodiments, an aqueous farm system includes a bracket for a plurality of plants. Each of the plants may be at least partially in a hole or opening in a barrier, with the plants removable from the holes through movement of the bracket. The bracket may have a base with multiple holes or housings that each couple to a plant, with arms extending from the base. The arms may be grasped during harvesting operations so as to extract the plant from the holes in the barrier. In some embodiments the arms may extend a distance from the base sufficient to clear a crop canopy, allowing for the arms to be grasped without damaging parts of the canopy. In some embodiments the base extends sufficiently away from the plants such that the arms may extend from portions of the base away from the plants. In some other embodiments, the arms may include, or be replaced by, slots into which an end of a coupling shaft or pole may be inserted and engaged. The shafts or poles may then be used to move the bracket.

In accordance with some embodiments, the bracket may have a base that extends along a longitudinal axis from a first end to a second end. Openings may be defined through the base from a first surface of the base to a second surface of the base, the second surface substantially parallel to the first surface. The openings may be substantially perpendicular to the longitudinal axis, with each of the openings being configured to receive a plant or a plant receptacle. A first arm may extend outwards from the first surface of the base proximate the first end of the base, with the first arm substantially perpendicular to the longitudinal axis of the base, and a second arm may extend outwards from the first surface of the base proximate the second end of the base, with the second arm substantially perpendicular to the longitudinal axis of the base.

In some embodiments plant receptacles, to hold the plants, are in the openings defined through the base. In some embodiments the plant receptacles include a housing with opposing openings, with one opening larger than the other. Roots of the plant may extend into an aqueous environment through the smaller opening, with the plant canopy extending above the larger opening.

In some embodiments, each plant receptacle may include a body having a first surface, a second surface, and a sidewall with an opening defined through the body from the first to the second surface along a longitudinal axis of the body. A collar on the first surface of the body may have a ledge. The ledge may extend outward from the opening in a plane that is a substantially perpendicular to the longitudinal axis of the body and protrude past the outer surface of the sidewall of the body. A sidewall of the collar may protrude outward from the first surface of the body to define an enclosure around the opening and ledge.

In accordance with some embodiments, the plant receptacle further includes one or more wings that extend outward from the sidewall of the collar. In accordance with many of these embodiments, a first wing may extend outward from a first side of the sidewall of the collar and a second wing may extend outward from a second side of the collar opposite the first side. In accordance with a number of these embodiments, the collar of the plant receptacle has a niche defined in the outer sidewall of the collar under at least one of the first and second wing proximate the ledge of the collar.

In accordance with some embodiments, the plant receptacle may include a root sheath. The root sheath may have a sidewall that extents outward from the bottom surface of the body substantially parallel to the longitudinal axis of the body to surround the opening through the bottom surface of the body. In accordance with many of these embodiments, the root sheath may also have a coupling ledge that extends between the sidewall of the body and the sidewall of the sheath along the bottom surface of the body in a plane substantially perpendicular to the longitudinal axis of the body. In accordance with a number of these embodiments, a bottom surface of the root sheath has a first side that extents towards the base of the receptacle in a first plane that forms an acute angle with respect to the longitudinal axis of the plant receptacle. In accordance with a few of these embodiments, the bottom surface of the root sheath may have a second side that extents towards the base of the receptacle in a second plane that forms an acute angle with respect to the longitudinal axis of the plant receptacle.

In accordance with some embodiments, a grow wall may be a wall having a first side surface and a second side surface with openings defined through the wall from the first side surface to the second side surface. Each of the openings may be configured to receive a plant receptacle. In accordance with many of these embodiments, a wall coupling configured to receive a bottom side of the bracket assembly surrounding one of the plurality of openings in the bracket assembly and/or a plant receptacle may be placed in and/or around an opening in the wall. In accordance with a number of these embodiments, the wall coupling may include a base having a top surface and a bottom surface with an opening defined through the base from the first surface to a second surface. A hood may protrude out of the base over the opening with a surface extending in a plane that forms an acute angle with a plane of the top surface of the base and an opening defined through the hood from the surface to the opening through the base.

These and other embodiments in accordance with aspects of the invention are more fully comprehended on review of this disclosure.

### BRIEF DESCRIPTION OF THE FIGURES

FIG. 1 illustrates portions of an aqueous growing system in accordance with aspects of the invention.

FIG. 2 is a perspective view of a grow wall in accordance with an embodiment of the invention.

FIG. 3 is a bottom perspective view of a bracket in accordance with an embodiment of the invention.

FIG. 4 is a top perspective view of the bracket shown in FIG. 3.

FIG. 5 is a top view of the bracket shown in FIG. 3.

FIG. 6 is a side perspective view of the bracket shown in FIG. 3.

FIG. 7 is a top front perspective view of a bracket with legs in accordance with an embodiment of the invention.

FIG. 8 is a top front perspective view of the bracket of FIG. 7, with plant receptacles installed, in accordance with an embodiment of the invention.

FIG. 9 is a front perspective view of a plant receptacle in accordance with an embodiment of the invention.

FIG. 10 is a rear perspective view of the plant receptacle of FIG. 7.

FIG. 11 is a top perspective view of a wall coupling in accordance with an embodiment of the invention.

### DETAILED DESCRIPTION

Large scale aqueous farm systems such as, but not limited to, aeroponic farm systems may include grow walls. For an aeroponic farm, the grow walls typically are part of an enclosure for a mist environment. A grow wall may have openings in which plants are placed, with root systems of the plants extending into the mist environment and a canopy of the plant extending out into an atmospheric environment. The grow wall therefore serves as a barrier or separation between an aqueous environment and an atmospheric environment. In some embodiments barriers or separations other than grow walls may be used, and in some embodiments the aqueous farm system may be a hydroponic farm system.

In some embodiments the plants are placed in plant receptacles, which in turn are placed in the openings of the grow walls. Generally, the root systems of the plants extend out of one end of the plant receptacles, and the canopy of the plant extends out another end of the plant receptacle. The plant receptacle may be coupled to the wall in a way that seals the mist environment inside the wall.

A bracket in accordance with some embodiments of the invention may be an assembly may be used to handle the plant receptacles. Particularly, the bracket may include a portion positioned between a barrier, for example a grow wall, and part of a plurality of plant receptacles. The bracket may be used to remove a group of one or more plant receptacles from the grow wall. In accordance with some embodiments the bracket may have multiple holes or housings in a longitudinal base of the bracket that each hold or affix to a plant receptacle, and arms extending from the base of the bracket that allow the bracket to be handled away from the canopies and/or roots protruding out the receptacles. The arms may be at opposing ends of a longitudinal base of the bracket. The arms of the bracket may be handles that extend out from the opposite sides of the bracket that may be grasped away from the canopies or roots of the receptacles in some embodiments. In some other embodiments, the arms may be replaced by slots into which an end of a coupling shaft or pole may be inserted and engaged. The shafts or poles may then be used to move the bracket.

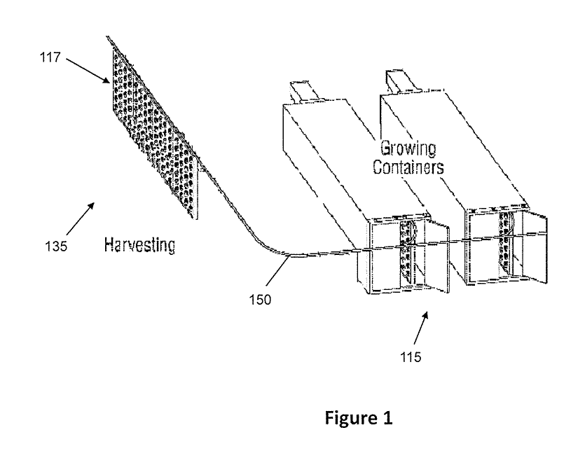

FIG. 1 illustrates a portion of large scale aeroponic farm that is representative of an aqueous farm system in accordance with some embodiments of the invention. The large scale aeroponic farm includes growing containers 115, and a harvesting station 135. Generally, a climate and/or aqueous circulation control systems (not shown) may be used in providing appropriate environmental conditions within the growing containers or parts thereof. As illustrated, the growing containers and harvesting station are connected by an overhead track system 150.

In FIG. 1, the plants are housed in plant receptacles. The plant receptacles are placed in grow walls, for example grow wall 117, that may be comprised of multiple grow panels. In the embodiment of FIG. 1, each grow wall has one or more couplings that affix the grow wall to the track system. The track system may be used to move the grow walls from the growing containers to the harvesting station. After the plants in the growing containers have matured and are ready to be harvested, the grow wall is moved to the harvesting station. A more detailed description some components of an aeroponic farm system that uses grow walls and plant receptacles in accordance with some embodiments of the invention is provided in U.S. patent application Ser. No. 15/360,876 entitled “Plant Growing Systems and Methods” filed Nov. 23, 2016 that is hereby incorporated by reference for all purposes as if set forth herewith.

Aqueous farm systems, including aeroponic farm systems, in accordance with some embodiments of this invention allow automated retrieval of plants from a growing wall using a bracket. The bracket may allow multiple plant receptacles in a growing wall to be engaged by an automated system at one time for handling. Furthermore, the configuration of the bracket may reduce and/or prevent contact between the automated system and plant canopies of the plants in the receptacles to reduce and/or prevent damage to the plants.

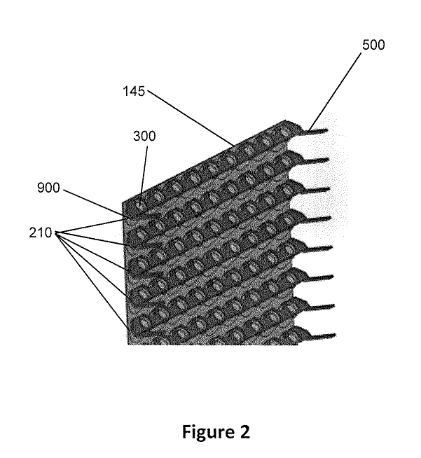

FIG. 2 illustrates a portion of a panel of a grow wall with brackets in accordance with aspects of the invention. The panel may be part of a structure that encloses an aqueous environment, for example a mist of an aeroponic environment. The grow wall has plant receptacles in openings of the wall, with brackets holding the plant receptacles. Roots of the plants would be exposed in the aqueous environment out one end of the plant receptacle, with a canopy of the plant exposed to an external atmospheric environment out the other end of the plant receptacle.

In FIG. 2, a panel 145 of a grow wall has openings 210 defined through wall 145. In accordance with the shown embodiment, openings 210 are configured in an array of rows and columns. However, various other embodiments may have the openings 210 configured in wall 145 in other arrangements. In some embodiments, and in the embodiment of FIG. 2, a wall coupling 900 surrounds each opening 210 through wall 145, and the wall coupling is configured to receive a plant receptacle 300 being held by a bracket 500. In accordance with some embodiments, a wall coupling 900 may be configured to hold a plant receptacle in a given orientation with respect to wall 145. In accordance with many embodiments, a portion of a wall coupling 900 is inserted into an opening 210 to hold the wall coupling in place.

Each bracket 500 is between, or in some embodiments partially between, the plant receptacles 300 and wall couplings 900. In accordance with the shown embodiment, each bracket 500 holds a row of plant receptacles 300. In accordance with some other embodiments, each bracket holds a portion of a row of plant receptacles. In accordance with some other embodiments, each bracket 500 holds plant receptacles 300 in a same column. In a number of other embodiments, each bracket 500 holds a certain number of plant receptacles 300 in particle rows and columns forming a particular polygonal shape such as, but not limited to, a square and a rectangle. Each bracket 500 includes one or more couplings that allow an automated movement device to couple to an assembly bracket assembly 500 to insert and/or remove the plant receptacles from the openings 210 in wall 145.

Bracket assemblies 500, plant receptacles 300, and wall couplings 900 in accordance with various embodiments of the invention are described in more detail below.

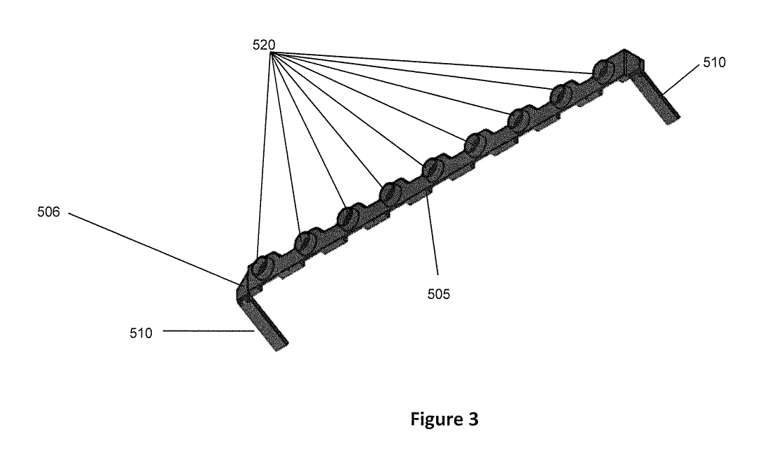

In accordance with some embodiments of the invention, a bracket assembly is provided for use in the automated handling of plants. The bracket holds a group of one or more plant receptacles and allows an automated system to couple to the bracket in a manner that does not interfere with the exposed plant canopies and/or root systems of the plants housed in the receptacles. This allows an automated system to handle the plant receptacles to safely insert and/or remove the receptacles from the growing as well as transport the plant receptacles, and plants held by the plant receptacles, outside the grow wall. Various views of a bracket in accordance with an embodiment of the invention are shown in FIGS. 3-8.

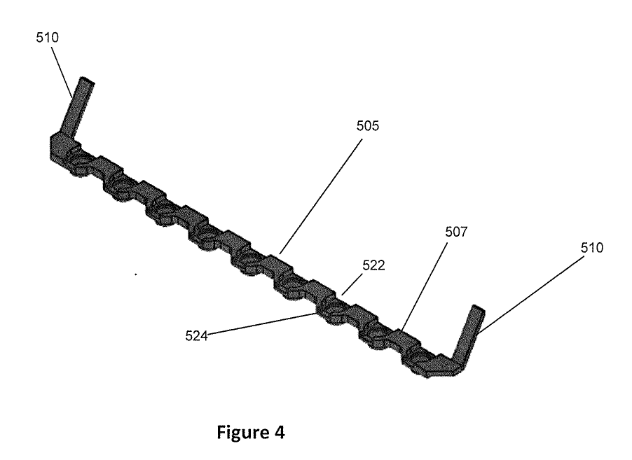

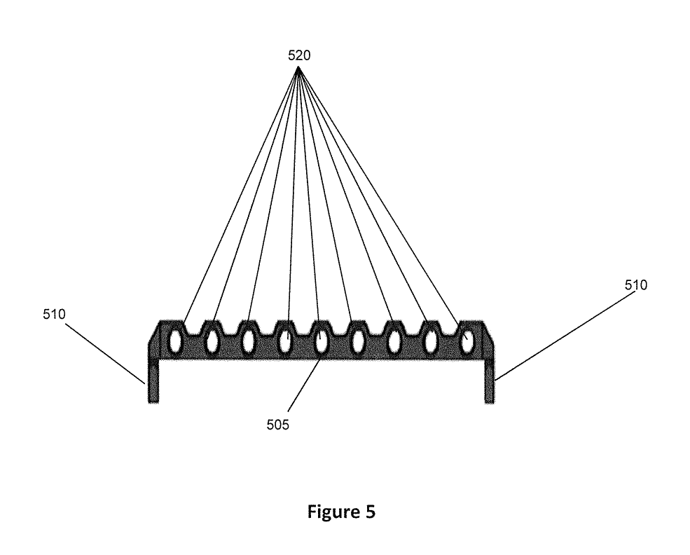

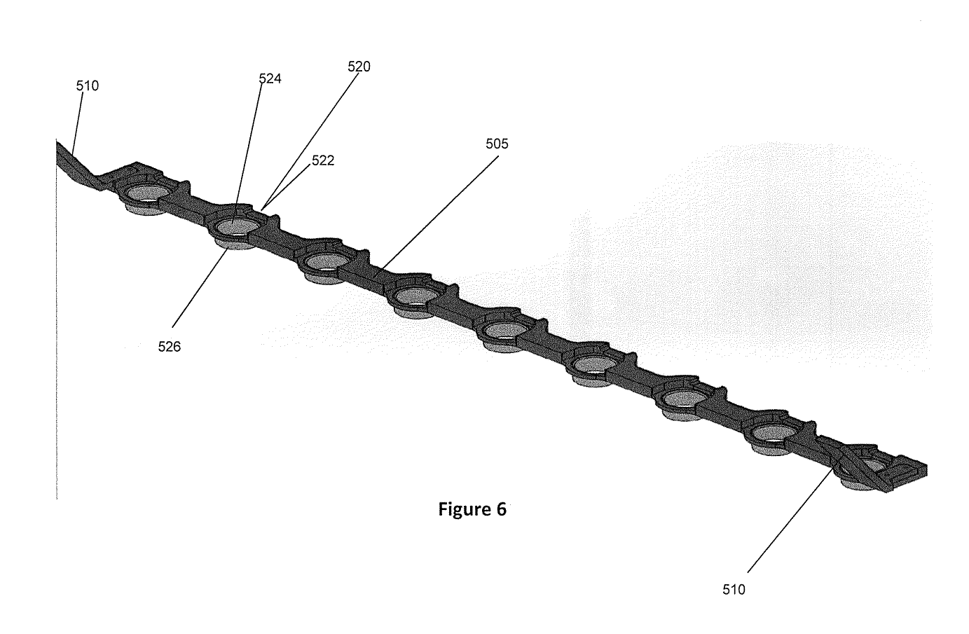

FIG. 3 is a bottom perspective view of a bracket in accordance with an embodiment of the invention. FIG. 4 is a top perspective view of the bracket shown in FIG. 3. FIG. 5 is a top view of the bracket shown in FIG. 3. FIG. 6 is a side perspective view of the bracket shown in FIG. 3. Bracket 500 has a base 505. Base 505 extends along a longitudinal axis from a first end to a second end with a top surface and a bottom surface. In the shown embodiment, the base is rectangular. However, base 505 may be various other shapes in accordance with various other embodiments of the invention. Openings 520 are defined through base 505 from the top surface to the bottom surface substantially perpendicular to the longitudinal axis. In the shown embodiments, openings 520 are substantially circular. However, openings 520 may be various other shapes in accordance with various other embodiments of the invention.

In accordance with the shown embodiment, base 505 has sufficient length and width to have an opening for a corresponding opening in a single row of openings in a grow wall. In accordance with some other embodiments, base 505 may have sufficient length for a lesser number of openings in a row. In accordance with many embodiments, base 505 may also have a sufficient width for openings corresponding to two or more openings of a grow wall in a column. Each opening 530 is configured to receive one plant receptacle. However, the openings 530 in accordance with a number of embodiments may be configured to receive more than one plant receptacle.

Bracket 500 has a coupling system that allows an automated system to couple to the bracket with interfering with the canopies and/or root system exposed by plant receptacles affixed to the assembly. In the shown embodiment, the coupling system is a pair of arms 510 that extend out of opposing end of base 505. A first arm 510 extends outwards from the top surface of base 505 proximate the first end of base 505 at a substantially perpendicular angle to the longitudinal axis of the base and a second arm 510 extends outwards from the top surface of base 505 proximate the second end of base 505 at a substantially perpendicular angle to the longitudinal axis of the base. Each arm may be gripped by a robotic arm, clap, or other gripping device so that the automated system may move the bracket 500 and in turn the plant receptacles (and plants held therein) using an automated system. In accordance with some other embodiments, slots may be defined in the opposing ends to allow a fork, rod, or some other device with an extended shaft to be inserted into the slot to move the bracket 500. In the shown embodiment, the arms 510 extend outward from base 505 at an acute angle with respect to the top surface of base 505 to facilitate handling when bracket 500 is affixed to plant receptacles 300 that are inserted in the growing wall. However, brackets in accordance with various other embodiments may have arms that extend outward at other angles.

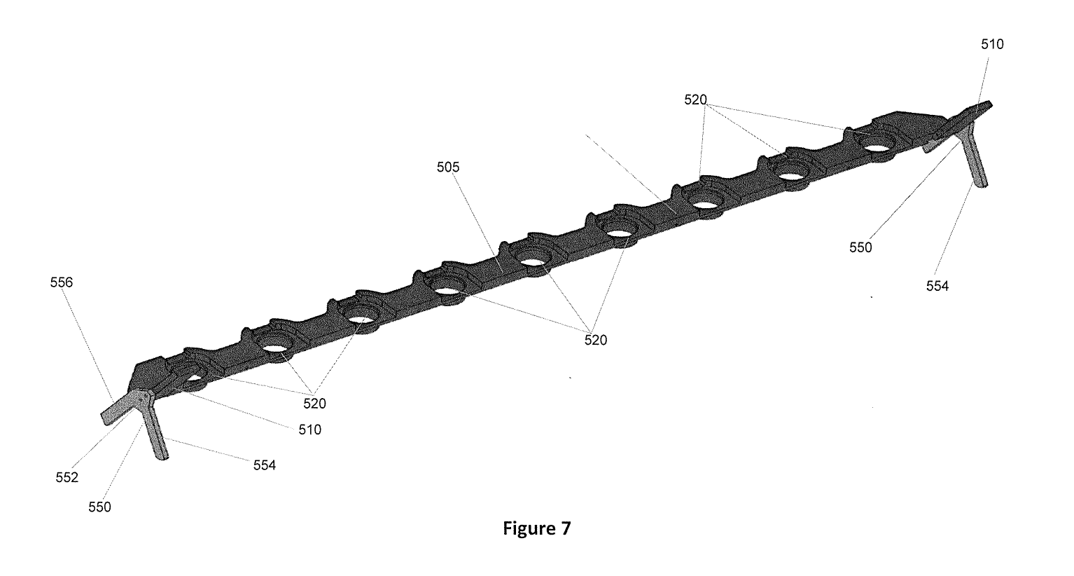

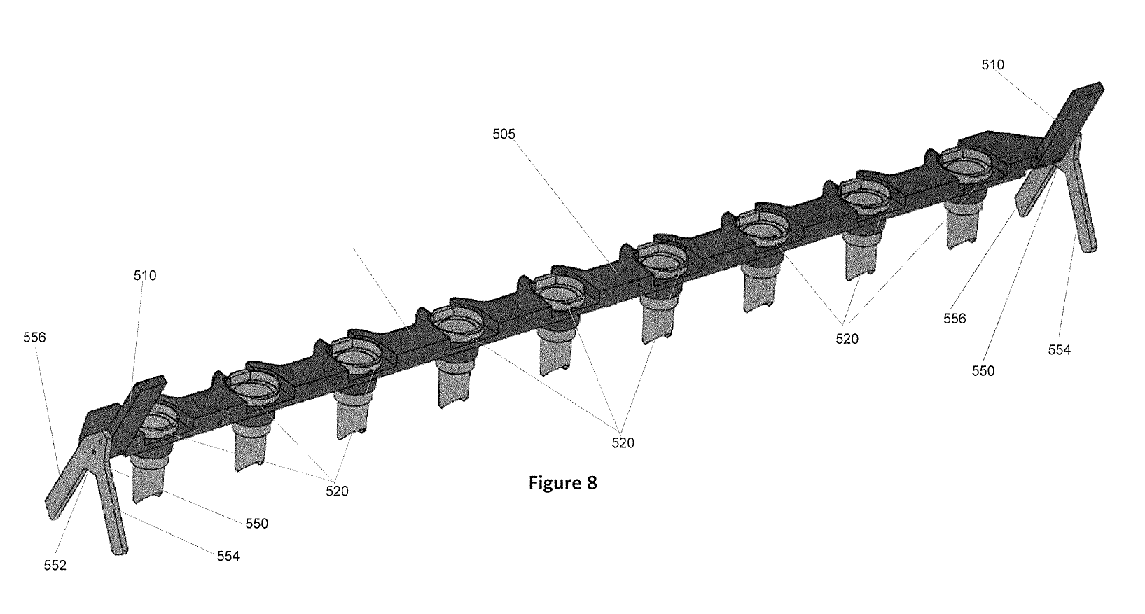

A collar coupling 522 surrounds each of the openings 520 in base 505. The collar couplings 522 cooperates with the collar 310 of a plant receptacle 300 (for example as shown in FIGS. 7-8) to align and/or secure a plant receptacle 300 in a desired orientation in the opening 520. In the shown embodiment, a collar coupling 522 is defined in the top surface of base 505 over one of the openings 520. Each collar coupling 522 has a ledge within base 505 that extends substantially perpendicularly from an edge of the opening 520 to a sidewall and the sidewall extends to the top surface of base 505.

Each collar coupling 522 may have one or more recessed notches that receive one or more corresponding wings 312 of a plant receptacle 300. In the shown embodiment, notches 524 are defined in each collar coupling 522. Each notch 524 is a void defined within the top surface and a portion of the sidewall of base 505 in a shape designed to receive a wing that extends out of a side of a plant receptacle.

A wall coupling collar 526 surrounds an opening on the bottom surface of base 505 and is configured to fit within an opening of wall coupling 900. In the shown embodiment, each wall coupling collar 526 extends out of the bottom surface of base 505 and is a sidewall that surrounds one of the openings 520 through base 505.

In accordance with some embodiments of the invention, the bracket may include legs for standing the bracket on a surface. A bracket with leg in accordance with an embodiment of the invention is shown in FIGS. 7 and 8. In the embodiment of FIGS. 7 and 8 legs 550 are connected to opposing ends of base 505. In the shown embodiment, the leg assemblies 550 are affixed to the sidewalls of the opposing ends of bracket 500. However, leg assemblies 550 may be attached to other portions of base 505 in accordance with various other embodiments of the invention. Furthermore, the legs may be retractable and/or detachable in accordance with some other embodiments of the invention, and in some embodiments the legs may be integrally formed with the bracket.

In FIGS. 7 and 8 two legs 554, 556 extend in different directions from a common location, creating a y-like formation. The legs may be considered co-planar, namely extending in and defining a common plane, with direction of extension of the legs differing by for example sixty degrees (although in various embodiments this may instead be in the range of thirty degrees to one hundred twenty degrees). Installed on opposing sides of the base 505 of the bracket, as shown in FIGS. 7 and 8, the legs 254, 256 may be considered to extend downward from a bottom side of a bracket with the bottom ends, or feet, of each of the legs 254, 256 resting on a surface and providing support to the bracket. As shown in FIG. 8, the legs may have a sufficient length to allow the bracket to be placed on a surface with plant receptacles installed in the bracket. In accordance with some further embodiments, the legs may have a sufficient length to allow plant the bracket to be placed on a surface without root systems extending from the bottom of installed plant receptacles touching or minimally touching the surface. The legs may provide benefit, therefore, in allowing a bracket holding mature plants to be stably placed on a floor or other surface without damage to the plants (or their fruit) by contact with the floor.

Although brackets in accordance with various embodiments of the invention are described above with reference to FIGS. 3-8, other brackets or bracket assemblies that add, combine, modify, and/or combine components as required by the configuration particular aqueous farm systems in accordance with various other embodiments are possible.

A plant receptacle generally holds in place a plug including a plant in an aeroponic system. The root system of the plant may be exposed through an opening on one side of the receptacle and a canopy of the plant that includes the stem leaf and other portion of the plant may be exposed through a second side. In accordance with some embodiments of the invention, a plant receptacle fits into an opening in a grow wall such that the root system of the plant is exposed inside a mist environment at least partially defined by the grow wall.

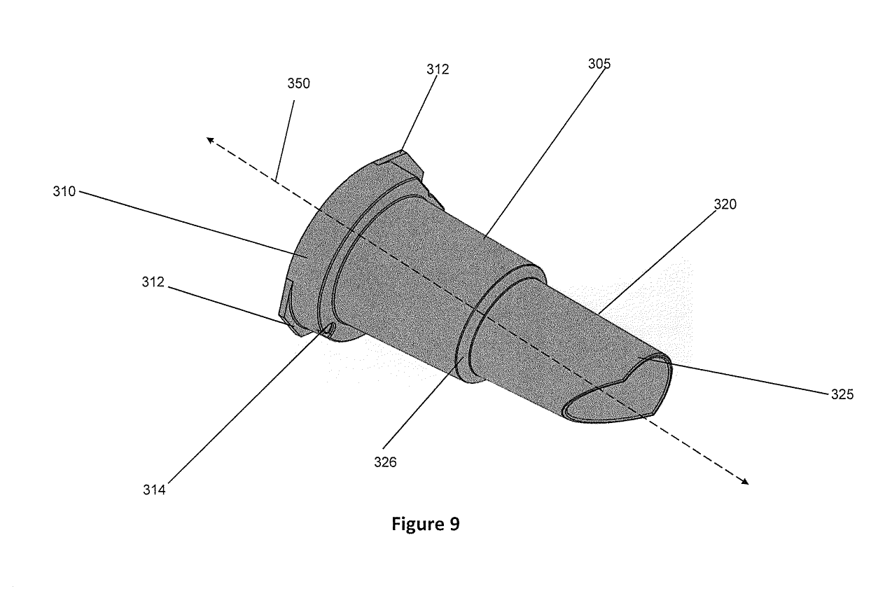

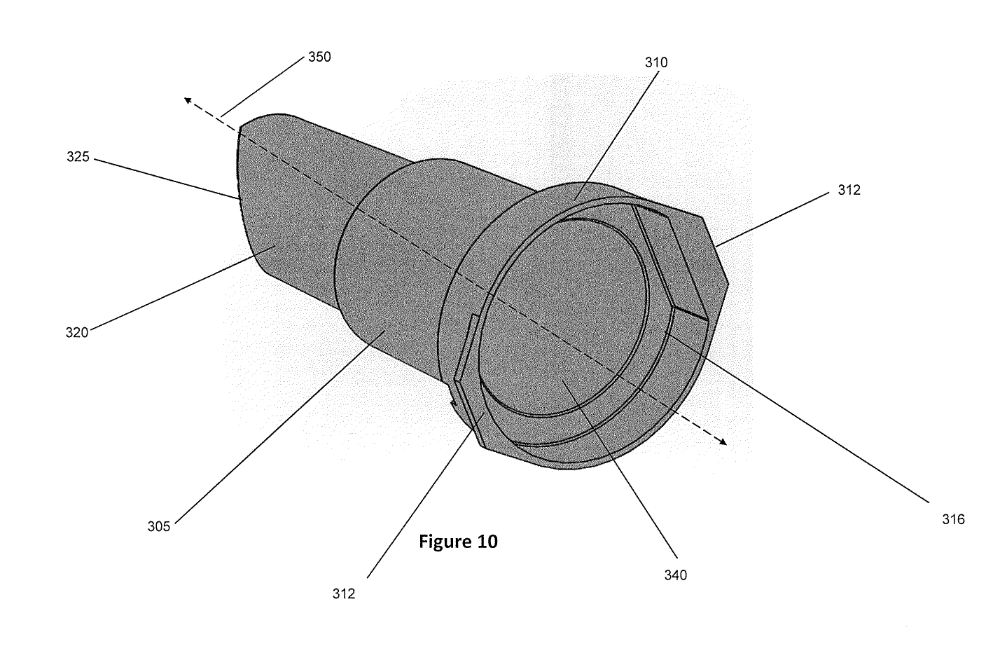

FIG. 9 illustrates a rearward perspective view of a plant receptacle in accordance with an embodiment of the invention. FIG. 10 illustrates a forward perspective view of the plant receptacles of FIG. 9. The plant receptacle 300 includes a body 305 that holds a plug in place in receptacle 300. Body 305 may include internal components that are used to hold the plug and/or plant in place. Examples of these internal components for holding a plant and/or plug in place include, but are not limited to, an annulus, a retaining ring, a detent, and a tongue, for example those that are described in the previously mentioned U.S. patent application Ser. No. 15/360,876 entitled “Plant Growing Systems and Methods” filed Nov. 23, 2016, that was previously incorporated by reference.

Base 305 has a top surface, a bottom surface, and a sidewall as well as a longitudinal axis 350. An opening 340 is defined through the body 305 from the top surface to the bottom surface along longitudinal axis 350. In accordance with the shown embodiment, opening 240 and base 205 are substantially cylindrical. However, base 305 and/or opening 316 may be other volumetric shapes in accordance with various other embodiments of the invention.

A collar 310 on the top surface of body 305 has a ledge 316 and a sidewall. Ledge 316 extends outward from the edge of opening 310 proximate the top surface of body 305 in a plane substantially perpendicular to longitudinal axis 350 and protrudes past the outer surface of the sidewall of body 305. The sidewall of collar 310 protrudes outward from the top surface of ledge 316 at or proximate the outer edge of ledge 216 to define an enclosure around opening 340 of base 205. In the shown embodiment, the sidewall of collar 310 is substantially cylindrical with two flat substantially parallel portions on opposing sides of plant receptacle 300. However, the sidewall of collar 310 may have other shapes in accordance with various other embodiments of the invention. The flat portions of the sidewall cooperate with components of bracket assembly 500 to align a plant receptacle 300 in a desired orientation within an opening of bracket assembly 500 in accordance with some embodiments of the invention.

In addition, plant receptacle 300 includes wings 312 that extent outward from the sidewall of collar 310 at substantially the top surface of collar 310. In accordance with the shown embodiments, the wings 312 extend out from collar 310 at or proximate the flat portions of the sidewall. The wings 312 may be used for handling of the receptacle; for aligning plant receptacle 300 in an opening in the bracket 500; and/or for purposes of coupling plant receptacle 300 to bracket 500 and/or wall coupling 900. In accordance with various other embodiments, the collar 310 may have any number of wings configured in any other fashion.

One or more niches 314 are defined on a bottom outer surface of ledge 316 for use in aligning and/or coupling plant receptacle 300 to bracket assembly 500 and/or wall coupling 900. In accordance with the shown embodiment, a niche 314 is aligned under a center point of a wing 312. However, one or more niches 314 may be in any location along the ledge 316 and/or sidewall of collar 310 in accordance with various other embodiments of the invention.

A root sheath 320 extends out of the bottom surface of base 305 surrounding opening 240. The root sheath 320 covers a portion of the root system and allows the remainder of the root system to be exposed out of the bottom of the opening 340. Root sheath 320 has a sidewall that extends outwardly from the bottom surface of body 305 substantially parallel to the longitudinal axis 350 of the body surrounding opening 340 on the bottom surface of the body 305. A coupling ledge 326 extends between the sidewall of body 305 and the sidewall of root sheath 320 along the bottom surface of body 305 in a plane that is substantially perpendicular to longitudinal axis 350. The coupling ledge 326 may be used to hold the plug in place inside base 305; to align plant receptacle 300 with bracket assembly 500 and/or wall coupling 900; and/or to couple plant receptacle 300 to bracket assembly 500 and/or wall coupling 900. In accordance with the shown embodiment, root sheath 320 is substantially cylindrical in shape. However, root sheath 320 may be any other volumetric shape in accordance with various other embodiments of the invention.

A bottom surface 325 of root sheath 320 has one or more sloped sides to make the opening defined in the bottom surface of sheath 320 larger. The larger opening in the bottom surface allows for increased expose of the root system of the plant to a mist environment, as well as shields the root system from dripping water from plants or other structures above. In accordance with the shown embodiment, bottom surface 325 has a first side that extends towards base 305 of the receptacle 300 in a first plane that forms an acute angle with respect to the longitudinal axis 350 of plant receptacle 300 and a second side that extends towards base 305 of the receptacle 300 in a second plane that forms an acute angle with respect to the longitudinal axis 350 of the plant receptacle 300.

Although plant receptacles in accordance with various embodiments of the invention are described with respect to FIGS. 9-10, plant receptacles that add, combine, modify, and/or remove components in accordance with various other embodiments are possible.

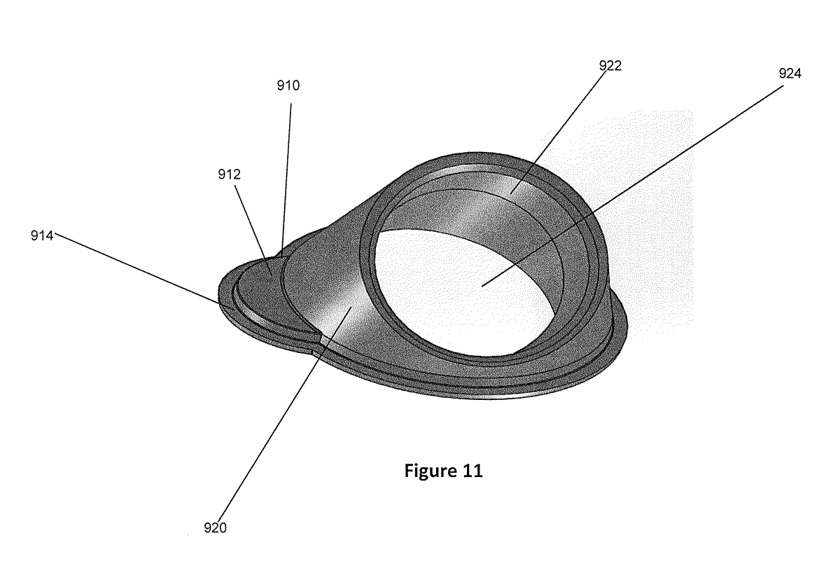

In accordance with some embodiments of the invention, a wall coupling is affixed to the growing wall over each opening 210 to align a plant receptacle in a desired orientation that extends through the opening 210. The wall coupling may cooperate with the plant receptacles and/or bracket assembly to secure the plant receptacles and/or bracket in place in the desired orientation within the openings 210. A wall coupling in accordance with an embodiment of the invention is shown in FIG. 11.

A wall coupling includes a base 910 and a hood 920. Base 910 has a top surface and a bottom surface with an opening defined through base 910 from the top surface to the bottom surface. In the shown embodiment, base 910 and the opening through base 910 are circular. However, base 910 and/or the opening through base 910 may be other shapes in accordance with various other embodiments of the invention.

A hood 920 protrudes out of the top surface of base 910 over the opening. Hood 920 has a surface in a plane that forms an acute angle with a plane of the top surface of base 910 and an opening 924 defined through hood 920 from the surface to the opening through base 910. A ledge 922 is defined within the sidewall of opening 924.

Ledge 922 cooperates with a ledge on the bottom of a planted receptacle 300 and/or a coupling collar in bracket assembly 500 to orient a plant receptacle and/or bracket assembly 500 at a proper depth within opening 924. The angle of the surface with respect to the base 910 causes the opening through wall coupling 900 to be at a desired angle with respect to the plane of a growing wall such that when a plant receptacle and/or bracket assembly is inserted into opening 924, the plant receptacle is in the desired orientation. In addition, base 910 includes wings 912 of material on the tope surface of base 910 on opposing sides of hood 920 to add structural support.

Although wall couplings in accordance with various embodiments of the invention are described above with respect to FIG. 11, other wall couplings that add, combine, modify, and/or combine components as required by the configuration of aqueous faun systems in accordance with various other embodiments are possible.

Although the invention has been discussed with respect to various embodiments, it should be recognized that the invention comprises the novel and non-obvious claims supported by this disclosure.

What is claimed is:

1. A bracket for use in holding plants in an aqueous farm system, comprising:
a base that has a plurality of openings, each of the plurality of openings configured to receive a plant;
a first arm extending outwards from the base; and
a second arm extending outwards from the base.

2. The bracket of claim 1, wherein the base extends along a longitudinal axis from a first end to a second end, and the first arm and the second arm are substantially perpendicular to the longitudinal axis.

3. The bracket of claim 2, wherein the first arm extends from the first end of the base and the second arm extends from the second end of the base.

4. The bracket of claim 1, wherein each of the plurality of openings is configured to receive a plant receptacle holding a plant.

5. The bracket of claim 4 wherein the base has a plurality of collar couplings defined in a top surface of the base, each of the plurality of collar couplings being defined over one of the plurality of openings and having a ledge within the base that extends from an edge of the opening to a sidewall that extends from the ledge to the top surface of the base and each of the plurality of collar couplings is configured to receive a collar of a one of the plant receptacles.

6. The bracket of claim 5 wherein the base has a plurality of notches defined in the plurality of collar coupling where each of the plurality of notches is a void defined with in the top surface and a portion of the sidewall that is configured to receive a wing guide that extends out of a side of the one of the plant receptacles.

7. The bracket of claim 1 wherein the base has a plurality of wall coupling collars that extend outward from a bottom surface of the base, wherein each of the plurality of wall coupling collars comprises a sidewall that surrounds one of the plurality of opening through the base.

8. The bracket of claim 1, further comprising a first pair of legs and a second pair of legs extending from the base.

9. A plant holding assembly for an aqueous farm system, comprising:
a bracket assembly including:
a base that extends along a longitudinal axis from a first end to a second end and having a top surface and a bottom surface with a plurality of openings defined through the base from the top surface to the bottom surface substantially perpendicular to the longitudinal axis wherein each of the plurality of openings is configured to receive one of a plurality of plant receptacles;
a first arm extending outwards from the top surface of the base proximate the first end of the base at a substantially perpendicular angle to the longitudinal axis of the base; and
a second arm extending outwards from the top surface of the base proximate the second end of the base at a substantially perpendicular angle to the longitudinal axis of the base; and
a plant receptacle including:
a body having a top surface, a bottom surface, and a sidewall with an opening defined through the body from the top surface to the bottom surface along a longitudinal axis of the body;
a collar on the top surface of the body having a ledge that extends outward from the opening in a plane substantially perpendicular to the longitudinal axis and protrudes past the outer surface of the sidewall of the body and a sidewall that protrudes outward from the top surface of body to define an enclosure around the opening.

10. The plant holding assembly of claim 9 wherein the plant receptacle further comprises a wing that extends outward from the sidewall of the collar.

11. The plant holding assembly of claim 9 wherein the plant receptacle further comprises a first wing that extends outward from a first side of the sidewall of the collar and a second wing that extends outward from a second side of the collar opposite the first side.

12. The plant holding assembly of claim 11 wherein the collar of the plant receptacle has a niche defined in the outer sidewall of the collar under at least one of the first and second wing proximate the ledge of the collar.

13. The plant holding assembly of claim 9 wherein the plant receptacle further includes:
a root sheath comprising a sidewall that extends outward from the bottom surface of the body substantially parallel to the longitudinal axis of the body surrounding the opening on the bottom surface of the body.

14. The plant holding assembly of claim 13 wherein the root sheath further comprises a coupling ledge extends between the sidewall of the body and the sidewall of the sheath along the bottom surface of the body in a plane that is substantially perpendicular to the longitudinal axis to the body.

15. The plant holding assembly of claim 14 wherein a bottom surface of the root sheath has a first side that extends towards the base of the plant receptacle in a first plane that forms an acute angle with respect to the longitudinal axis of the plant receptacle.

16. The plant holding assembly of claim 15 wherein the bottom surface of the root sheath has a second side that extends towards the base of the plant receptacle in a second plane that forms an acute angle with respect to the longitudinal axis of the plant receptacle.

17. The plant holding assembly of claim 9 further comprising:
a grow wall including a wall having a first side surface and a second side surface with a plurality openings through the wall from the first side surface to the second side surface wherein each of the plurality of opening is configured to receive a plant receptacle.

18. The plant holding assembly of claim 9 further comprising:
a wall coupling configured to receive a bottom surface of the bracket assembly surrounding one of the plurality of openings in the wall bracket.

19. The plant holding assembly of claim 18 wherein the wall coupling further comprises:
a base having a top surface and a bottom surface with an opening defined through the base from the first surface to a second surface; and
a hood that protrudes out of the base over the opening having a surface in a plane that forms an acute angle with a plane of the base and an opening defined through the hood from the surface to the opening through the base.
